(19) United States
(12) Patent Application Publication
(10) Pub. No.: US 2026/0049386 A1
(43) Pub. Date: Feb. 19, 2026

(54) Interspacer

(71) Applicant: Chromalloy Gas Turbine LLC, Palm Beach Gardens, FL (US)

(72) Inventors: Martinus Adam Petrus van den Bosch, Tilburg (NL); Wilco Bongers, Tilburg (NL); Antonius Mutsaers, Tilburg (NL)

(21) Appl. No.: 18/805,476

(22) Filed: Aug. 14, 2024

(51) Int. Cl. C23C 10/04; B05C 21/00; F01D 5/30

(52) U.S. Cl. CPC C23C 10/04; B05C 21/005; F01D 5/30; F05D 2230/90

(57) ABSTRACT

An interspacer is configured to be disposed in an area of a device. The area has a height. The interspacer includes a lower portion having a first end and a second end. The interspacer includes an upper portion extending above the lower portion and having a projecting member. The projecting member extends beyond the second end away from the first end. A height of the interspacer is equal to the height of the area.

### CROSS REFERENCE TO RELATED APPLICATIONS

None.

### FIELD OF THE DISCLOSURE

The disclosure relates generally to the field of masking devices. More specifically, the disclosure relates to an interspacer for selectively shielding a part undergoing a coating or other process.

### SUMMARY

The following presents a summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

In an aspect, an interspacer is configured to be disposed in an area of a device. The area has a height. The interspacer includes a lower portion having a first end and a second end. The interspacer includes an upper portion extending above the lower portion and having a projecting member. The projecting member extends beyond the second end away from the first end. A height of the interspacer is equal to the height of the area.

In an aspect, according to any one of the preceding aspects, the projecting member includes a projecting member end that includes a curved portion and an angled portion.

In an aspect, according to any one of the preceding aspects, the angled portion is above the curved portion.

In an aspect, according to any one of the preceding aspects, at least one of the first end and the second end extends non-perpendicularly from a bottom side of the lower portion In an aspect, according to any one of the preceding aspects, the lower portion includes a first side and a second side, and at least one of the first side and the second side is curved.

In an aspect, according to any one of the preceding aspects, the lower portion has a bulbous shape.

In an aspect, according to any one of the preceding aspects, the upper portion has a top side and the lower portion has a bottom side. The top side and bottom side extend parallel to each other.

In an aspect, according to any one of the preceding aspects, a width of the interspacer is equal to a width of the area.

In an aspect, according to any one of the preceding aspects, the interspacer is additively manufactured.

In an aspect of the disclosure, a method of selectively coating a component using an interspacer and a masking device is disclosed. The component has a projection. The interspacer has a lower portion and an upper portion. The upper portion has a projecting member. The method includes situating the component in an insertion area of the masking device. The method includes disposing an interspacer in the insertion area such that the projecting member contacts the component above the projection.

In an aspect, according to any one of the preceding aspects, the component is a gas turbine component.

In an aspect, according to any one of the preceding aspects, the gas turbine component is a blade.

In an aspect, according to any one of the preceding aspects, the blade is a compressor blade.

In an aspect, according to any one of the preceding aspects, the method includes selectively applying coating to the component while the projecting member is in contact with the component.

In an aspect, according to any one of the preceding aspects, the coating is diffusion aluminide coating.

In an aspect, according to any one of the preceding aspects, the lower portion has an end that extends non-perpendicularly from a bottom side of the lower portion in correspondence with the component.

In an aspect of the disclosure, a method of selectively shielding a component undergoing a process using an interspacer is disclosed. The component has a projection. The interspacer includes a lower portion and an upper portion that extends above the lower portion. The upper portion has a projecting member. The method comprises disposing the interspacer and at least a portion of the component within an insertion area of a masking device such that the projecting member contacts the component above the projection.

In an aspect, according to any one of the preceding aspects, the projecting member has a curved area. A curve of the curved area corresponding to an upper surface of the projection.

In an aspect, according to any one of the preceding aspects, the component is a gas turbine component.

In an aspect, according to any one of the preceding aspects, the process is a coating process.

### BRIEF DESCRIPTION OF THE DRAWINGS

Illustrative embodiments of the present disclosure are described in detail below with reference to the attached drawing figures and wherein:

FIG. 1 is a schematic view of a gas turbine engine, according to some aspects of the disclosure.

FIG. 2 is a perspective view of a fan blade, according to some aspects of the disclosure.

FIG. 3A is a front view of a compressor blade, according to some aspects of the disclosure.

FIG. 3B is a rear view of the compressor blade of FIG. 3A, according to some aspects of the disclosure.

FIG. 3C is an end view of the compressor blade of FIG. 3A, according to some aspects of the disclosure.

FIG. 3D is an opposing end view of the compressor blade of FIG. 3C, according to some aspects of the disclosure.

FIG. 4 is a perspective view of a masking device, according to some aspects of the disclosure.

FIG. 5 is a perspective view of the masking device of FIG. 4 with a plurality of compressor blades of FIGS. 3A-3D disposed in an insertion area thereof, according to some aspects of the disclosure.

FIG. 6 shows two compressor blades of FIGS. 3A-3D in an end-to-end configuration.

FIG. 7 is a perspective view of an interspacer, according to some aspects of the disclosure.

FIG. 8 is a front view of the interspacer of FIG. 7, according to some aspects of the disclosure.

FIG. 9 is a rear view of the interspacer of FIG. 7, according to some aspects of the disclosure.

FIG. 10 is an end view of the interspacer of FIG. 7, according to some aspects of the disclosure.

FIG. 11 is an opposing end view of the interspacer of FIG. 10, according to some aspects of the disclosure.

FIG. 12 schematically illustrates the interspacer of FIGS. 7-11 disposed at two opposing ends of the compressor blade of FIGS. 3A-3D, according to some aspects of the disclosure.

FIG. 12A is a closeup view of a portion of FIG. 12 illustrating the interspacer of FIGS. 7-11 disposed below a leading of the compressor blade of FIGS. 3A-3D.

FIG. 12B is a closeup view of a portion of FIG. 12 illustrating the interspacer of FIGS. 7-11 disposed below a trailing edge of the compressor blade of FIGS. 3A-3D.

FIG. 13 is a perspective view showing interspacers of FIGS. 7-11 situated between compressor blades of FIGS. 3A-3D within an insertion area of the masking device of FIG. 4, according to some aspects of the disclosure.

### DETAILED DESCRIPTION

A gas turbine engine typically includes a multi-stage compressor coupled to a multi-stage turbine via an axial shaft. The multi-stage compressor may include a low-pressure compressor and a high-pressure compressor, and the multi-stage turbine may include a low-pressure turbine and a high-pressure turbine. Air enters the gas turbine engine through the low-pressure compressor where its temperature and pressure are increased as it passes through subsequent stages of the compressor. The compressed air is then directed to one or more combustors where it is mixed with a fuel source to create a combustible mixture. This mixture is ignited in the combustors to create a flow of hot combustion gases. These gases are directed into the turbine causing the turbine to rotate, thereby driving the compressor. The output of the gas turbine engine can be mechanical thrust via exhaust from the turbine or shaft power from the rotation of an axial shaft, where the axial shaft can drive a generator to produce electricity.

The compressor and turbine each typically include a plurality of rotating blades and stationary vanes having an airfoil extending into the flow of compressed air or flow of hot combustion gases. Each blade or vane has a particular set of design criteria which must be met to provide the necessary work to the flow passing through the compressor and the turbine. However, due to the severe nature of the operating environment, especially in the turbine, it is often necessary to cool these blades and vanes. The blades and vanes often utilize complex internal cooling passageways in order to maximize the efficiency of cooling fluid passing therethrough.

Gas turbine engines also typically include a fan that may be disposed at the front of the engine. The fan may include a disc to which a plurality of fan blades is coupled. The fan may rotate to increase the amount of air moving through the engine, and therefore increase the engine's thrust. The size of the fan blades may be greater than the size of the compressor blades and the turbine blades.

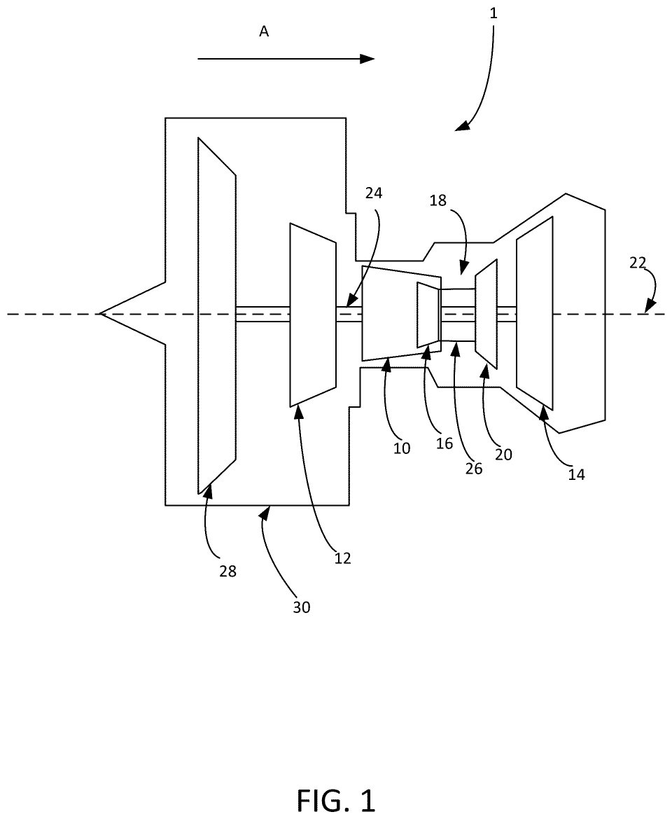

FIG. 1 schematically illustrates a gas turbine engine 1. The gas turbine engine 1 typically includes a generator 10, a low-pressure compressor 12, a low-pressure turbine 14, a high-pressure compressor 16, a combustion chamber 18, and a high-pressure turbine 20. Gases may flow into the gas turbine engine 1 in direction A, which may be parallel to a longitudinal axis 22 of the gas turbine engine 1. The low-pressure compressor 12 and low-pressure turbine 14 may be operably connected by low-pressure shaft 24 centered on longitudinal axis 22. Similarly, the high-pressure compressor 16 and the high-pressure turbine 20 may be operably connected via a high-pressure shaft 26 centered on longitudinal axis 22. The high-pressure shaft 26 may be arranged around the low-pressure shaft 24. The gas turbine engine 1 may also include a fan 28 that may be encased in a fan casing 30. The fan 28 may be disposed upstream the low-pressure compressor 12, and may include a plurality of fan blades 40 that rotate about longitudinal axis 22. Fan 28, in some examples, may be movably coupled to low-pressure shaft 24 and driven by the low-pressure turbine 14.

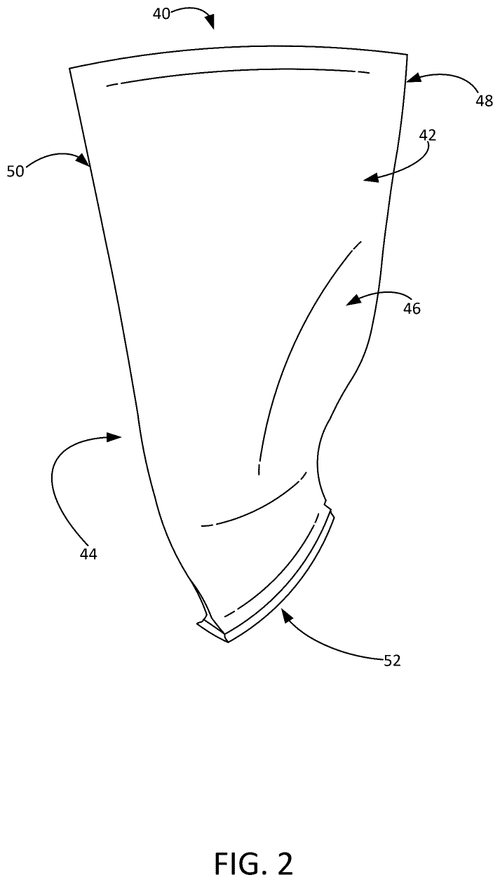

FIG. 2 shows a fan blade 40. Fan blade 40 may be one of a plurality of fan blades of fan 28 of FIG. 1, or one of a plurality of fan blades of another gas turbine engine fan. The fan blade 40 includes an airfoil 42, which has a pressure surface 44 (not clearly visible in FIG. 2) and a suction surface 46. The pressure surface 44 and suction surface 46 each extend from leading edge 48 to trailing edge 50 of airfoil 42. The fan blade 40 may, at a lowermost section thereof, include dovetail 52. Dovetail 52 may have a generally firtree shape.

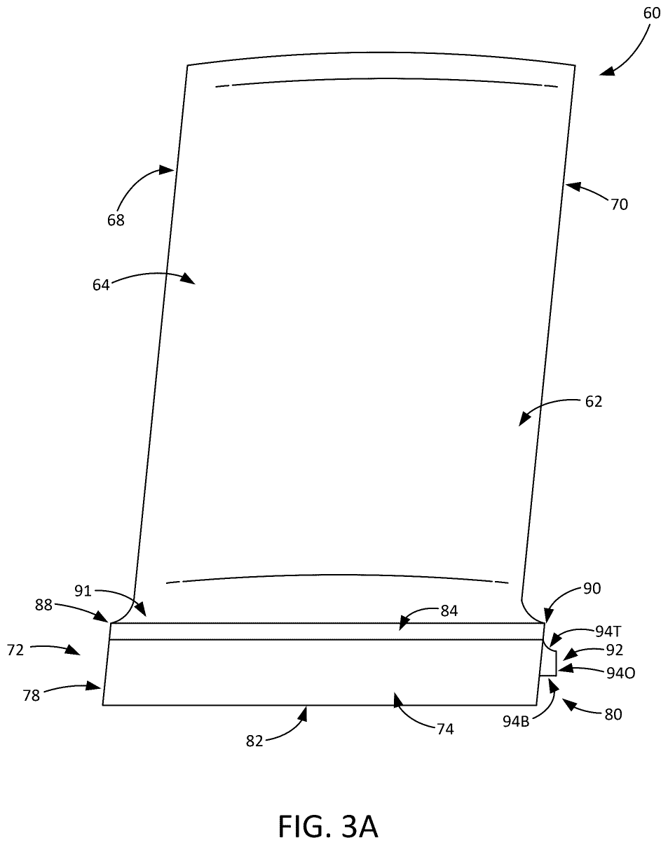

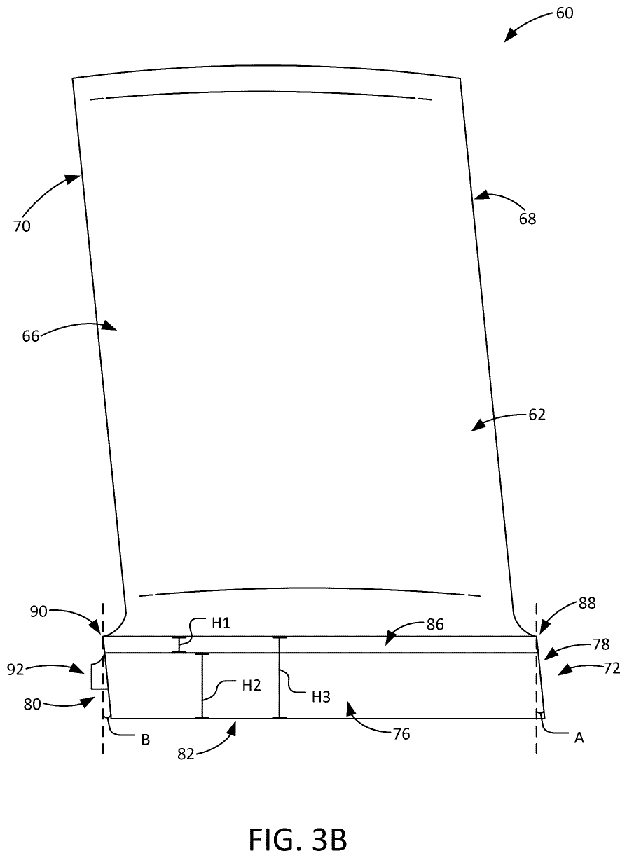

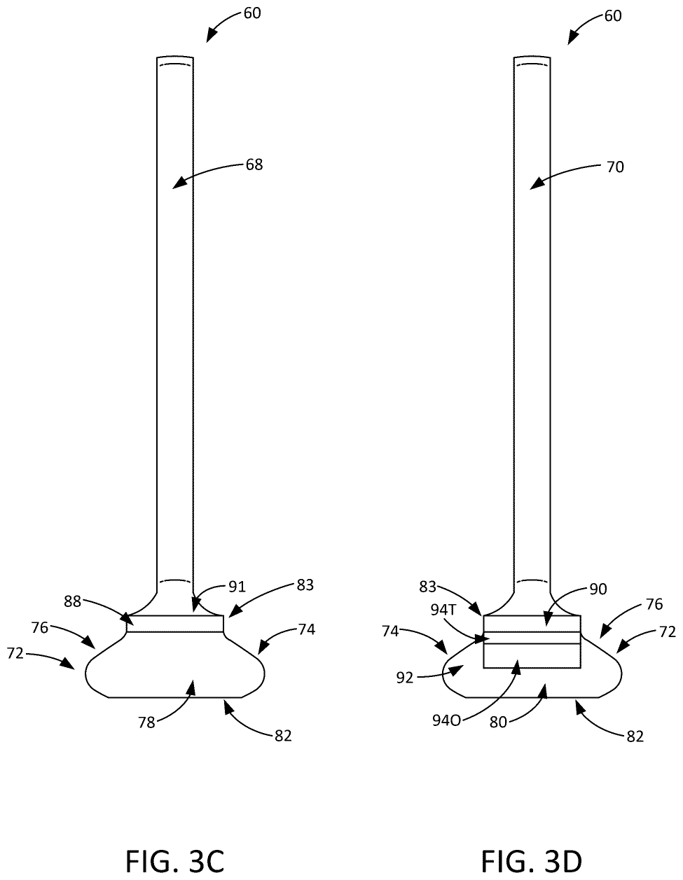

FIGS. 3A-3D show an example compressor blade 60. The compressor blade 60 may be one of a plurality of blades of low-pressure compressor 12, one of a plurality of blades of high-pressure compressor 16, or one of a plurality of blades of another low-pressure or high-pressure compressor (e.g., of another gas turbine engine). The compressor blade 60 may include an airfoil 62, which has a suction surface 64 (see FIG. 3A) and a pressure surface 66 (see FIG. 3B) opposing suction surface 64. Suction surface 64 and pressure surface 66 may each extend from leading edge 68 to trailing edge 70 of airfoil 62.

Compressor blade 60 may, at a lowermost section thereof, include a root portion or dovetail (hereinafter “root portion 72”). Root portion 72 may have a first side 74 (see FIG. 3A), a second side 76 (see FIG. 3B), a first end 78 (see FIG. 3C), a second end 80 (see FIG. 3D), and a bottom side 82. Each of first side 74, second side 76, first end 78, and second end 80 may extend upwards from bottom side 82.

First side 74 of root portion 72 may extend generally laterally below suction surface 64 of airfoil 62. Second side 76 of root portion 72 may oppose first side 74 and may extend generally laterally below pressure surface 66 of airfoil 62. First end 78 of root portion 72 may be below leading edge 68 and extend generally longitudinally from first side 74 of root portion 72 to second side 76 thereof. Second end 80 of root portion 72 may be below trailing edge 70 and extend generally longitudinally from first side 74 of root portion 72 to second side 76 thereof.

In some examples, bottom side 82 may be generally flat, whereas each of first side 74 and second side 76 that extend therefrom may be rounded (see FIGS. 3C and 3D). For instance, each of first end 78 and second end 80 of root portion 72 may have a generally bulbous or double frusto-elliptical shape. In other examples, any one or more of first side 74, second side 76, first end 78, second end 80, and bottom side 82 may be generally flat, rounded, or be formed in other symmetrical or asymmetrical shapes.

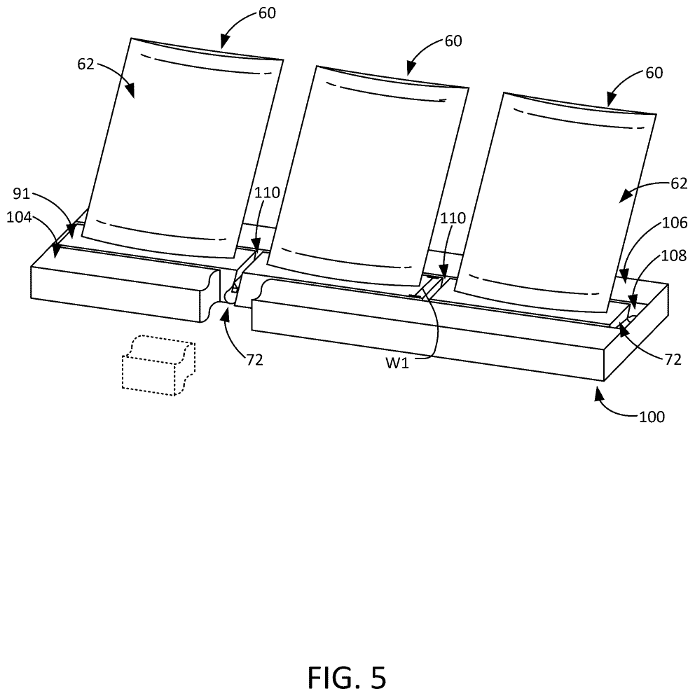

A platform 83 (see FIG. 3C) may be disposed between the airfoil 62 and the root portion 72. Airfoil 62 may extend above platform 83, and root portion 72 may extend below platform 83. Platform 83 may have a first side 84 (see FIG. 3A), a second side 86 (see FIG. 3B), a first edge 88 (see FIG. 3C), a second edge 90 (see FIG. 3D), and a top edge 91 (see FIGS. 3A and 5). First side 84 of platform 83 may extend generally laterally above first side 74 of root portion 72. Second side 86 of platform 83 may oppose first side 84 thereof and extend generally laterally above second side 76 of root portion 72. First edge 88 of platform 83 may extend generally longitudinally above first end 78 of root portion 72, and second edge 90 of platform 83 may extend generally longitudinally above second end 80 of root portion 72. Top edge 91 of platform 83 may oppose bottom side 82 of root portion 72. Airfoil 62 may extend from top edge 91.

In some examples, top edge 91 of platform 83 may have a width W1 (see FIG. 5). Platform 83 may have a height H1 (see FIG. 3B), and root portion 72 may have a height H2. Height H1 plus height H2, i.e., the combined height of platform 83 and root portion 72, may equal height H3.

In some examples of the embodiments, a protrusion may protrude from one or more of first side 74, second side 76, first end 78, and second end 80 of root portion 72 (and/or elsewhere from the compressor blade 60). For instance, projection 92 may protrude from second end 80 of root portion 72 away from first end 78 thereof. In some examples, and as illustrated in FIG. 3D, projection 92 may be downwardly adjacent second edge 90 of platform 83. In other examples, projection 92 may extend from platform 83 itself or from another portion of compressor blade 60.

Projection 92 may be spherical, cylindrical, pyramidal, or take on other symmetrical or asymmetrical shapes. In the illustrated example, projection 92 is asymmetrical and has a top surface 94T (see FIG. 3A), a bottom surface 94B, and an outermost surface 94O (see FIGS. 3A and 3D). The outermost surface 94O may extend between the top surface 94T and bottom surface 94B. In some examples, top surface 94T may be curved.

First end 78 of root portion 72 and first edge 88 of platform 83 may, in some examples, be planar. Similarly, in some examples, second end 80 of root portion 72 (ignoring the projection 92) and second edge 90 of platform 83 may be planar. In some examples, each of first edge 88 of platform 83 and first end 78 of root portion 72 may collectively form an angle A with the vertical (see FIG. 3B). Similarly, second edge 90 of platform 83 and second end 80 of root portion 72 (ignoring the projection 92) may form an angle B with the vertical. In some examples, angle A may be the same or generally the same as angle B (i.e., first end 78 of root portion 72 and first edge 88 of platform 83 may collectively extend parallel or generally parallel to second end 80 of root portion 72 and second edge 90 of platform 83). In other examples, angle A may be less than or greater than angle B. In some examples, first end 78 and/or second end 80 may extend upwards parallel to the vertical plane.

The hot gas path within a gas turbine engine, such as gas turbine engine 1, may be both thermally and chemically hostile. Improvements have been made to the high-temperature capabilities of gas turbine components via development of iron, nickel and cobalt-base superalloys. The capability of gas turbine parts to withstand the thermally and chemically hostile environment of the hot gas path within gas turbine engine 1 may also be improved via the use of oxidation-resistant environmental coatings capable of protecting these parts from oxidation and corrosion. As one example, aluminum-containing coatings, particularly diffusion aluminide coatings, may be used as an environmental coating on gas turbine components. During high temperature exposure in air, aluminum-containing coatings may form a protective aluminum oxide (alumina) scale or layer that inhibits corrosion and oxidation of the coating and the underlying substrate. As another example, thermal barrier coatings, such as ceramic coatings, may be applied to gas turbine components to thermally insulate these components within the hot gas path.

It may be desirable to apply one or more coatings, e.g., environmental barrier coatings, thermal barrier coatings, et cetera, to a gas turbine component selectively, e.g., to apply coating only to those portions of the gas turbine component that are exposed to the extremely high temperatures associated with the hot gas path of the gas turbine engine 1. For example, it may be desirable to apply coating to the compressor blade 60 such that only the airfoil 62 and top edge 91 of platform 83 are coated; that is, it may be desirable to ensure that the coating does not impact the root portion 72 and does not impact each of first side 84, second side 86, first edge 88, and second edge 90 of platform 83. If coating is inadvertently disposed, e.g., on the root portion 72 or on any of first side 84, second side 86, first edge 88, and second edge 90 of platform 83, the coating may add unnecessary weight to the compressor blade 60 and may adversely interfere with the coupling of the compressor blade 60 to the hub. Therefore, any coating that is inadvertently disposed on these surfaces may need to be removed, e.g., laboriously using a sanding, grit blasting, or other process. In some cases, the compressor blade 60 may need to be scrapped due to the inadvertent application of diffusion aluminide coating to the root portion 72 and/or the first side 84, second side 86, first edge 88, or second edge 90 of platform 83.

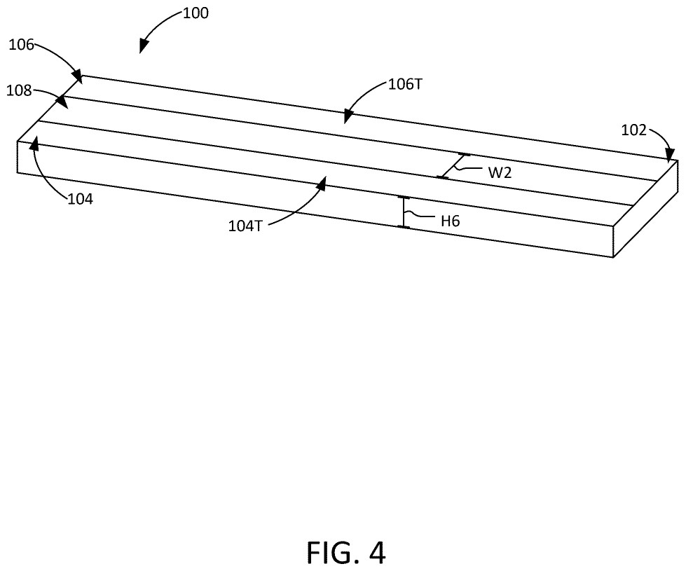

FIG. 4 shows a masking system 100 for selectively masking a component to be coated. For example, masking system 100 may be employed to selectively mask one or more surfaces of a component of a gas turbine engine, such as one or more surfaces of a compressor blade, a fan blade, a turbine blade, et cetera. For instance, the masking system 100 may be used to coat the airfoil of the blade without impacting the root thereof.

In some examples of the embodiments, masking system 100 includes a housing 102 for supportively retaining a plurality of blades that are to be selectively coated. The housing 102 may include a first member 104 and a second member 106 that each extend laterally along the length of the housing 102. First member 104 may have a top side 104T and second member may have a top side 106T. Top side 104T of first member 104 and top side 106T of second member 106 may be spaced apart from each other and define a cavity or insertion area (hereinafter “insertion area 108”) therebetween. Insertion area 108 may have a width W2 (see FIG. 4). Housing 102 may have a height H6, which in this example, may also be the height of the insertion area 108. Insertion area 108 may be configured to insertably receive one or more portions of the component to be selectively coated. For example, where the component is a blade, the root of the blade may be inserted into the insertion area 108 such that the airfoil of the blade extends above the housing 102. The blade may then be selectively coated, e.g., with diffusion aluminide coating or another coating, while the root of the blade is housed within the insertion area 108. The masking system 100 may mask the root of the blade and preclude the coating from being disposed on the root.

It may be more cost-effective and efficient to use the masking system 100 to selectively apply diffusion aluminide coating to a plurality of components, e.g., a plurality of blades, at the same time. The insertion area 108 may therefore be configured to insertably receive the root portions of a plurality of blades. The masking system 100 may allow for the airfoils of these blades to be coated while the root portions of the blades are masked and unaffected by the coating.

FIG. 5 shows root portions 72 of three compressor blades 60 insertably received within the insertion area 108 of the masking system 100, so that each of the three compressor blades 60 may be selectively coated, e.g., with diffusion aluminide coating, at the same time. In the illustrated example, it is desirable to selectively coat each compressor blade 60 such that only airfoil 62 and top edge 91 of platform 83 of each compressor blade 60 is coated (e.g., because the airfoil 62 and top edge 91 of platform 83 of each compressor blade 60 is in the hot gas path of the gas turbine engine 1). That is, it is desirable to mask each of the root portion 72, and the first side 84, second side 86, first edge 88, and second edge 90 of platform 83 of each compressor blade 60, so as to ensure that these portions of the compressor blades 60 are not coated with, or are only minimally impacted by, the diffusion aluminide coating.

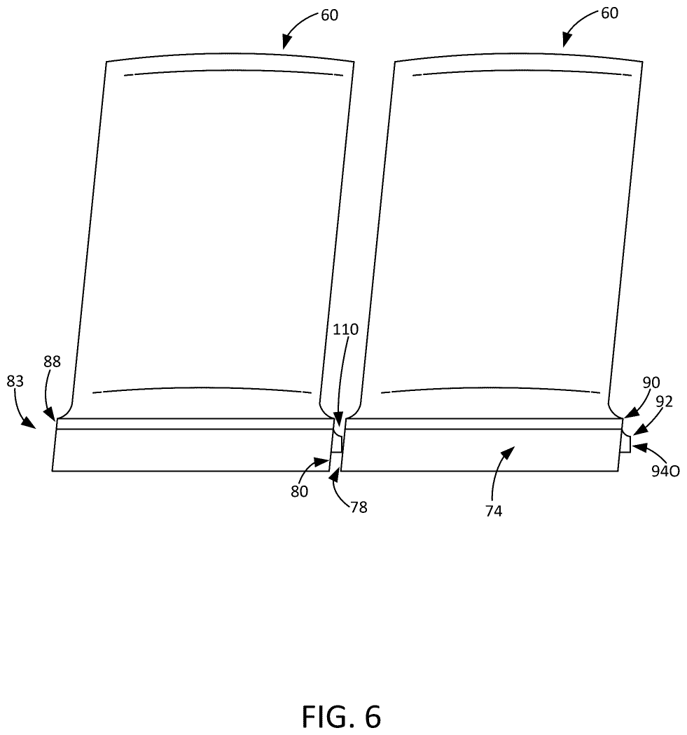

As shown in FIG. 5, root portions 72 of the three compressor blades 60 are disposed side by side in the insertion area 108 of masking system 100. When the compressor blades 60 are so arranged, the second end 80 (see FIG. 3A) of root portion 72 of one compressor blade 60 faces the first end 78 (see FIG. 3A) of root portion 72 of the adjacent compressor blade 60. More particularly, as shown more clearly in FIG. 6, when the compressor blades 60 are arranged side by side, e.g., in insertion area 108 (see FIG. 5), projection 92 extending from second end 80 of root portion 72, and more particularly, outermost surface 94O (see FIG. 3A) of projection 92, contacts and abuts first end 78 of root portion 72 of the adjacent compressor blade 60. The projection 92 precludes platforms 83 of the adjacent compressor blades 60 from contacting each other, and causes a gap 110 (see FIG. 5) to be formed between first edge 88 (see also FIG. 3C) of platform 83 one compressor blade 60 and second edge 90 (see also FIG. 3D) of platform 83 of the adjacent compressor blade 60. The gap 110 may adversely interfere with the selective coating of the compressor blades 60. That is, if the masking system 100, with the three compressor blades 60 positioned as shown in FIG. 5, is placed in a container as discussed above to selectively apply diffusion aluminide coating to the compressor blades 60 (i.e., so that only the airfoil 62 and the top edge of 91 of platform 83 of each compressor blade 60 is coated), at least some diffusion aluminide coating may pass through the gap 110 and result in undesirable application of diffusion aluminide coating to the root portion 72 and/or one or more of first side 84, second side 86, first edge 88, and second edge 90 of platform 83 of the compressor blades 60. The aluminide diffusion coating on the root portion 72 and/or one or more of first side 84, second side 86, first edge 88, and second edge 90 of platform 83 of each compressor blades 60 then must be laboriously removed, which is undesirable. In some cases, one or more of the compressor blades 60 must be scrapped. It may be desirable to ensure that application of aluminide diffusion coating on the root portion 72 and/or one or more of first side 84, second side 86, first edge 88, and second edge 90 of platform 83 of each compressor blade 60 is precluded or at least minimized.

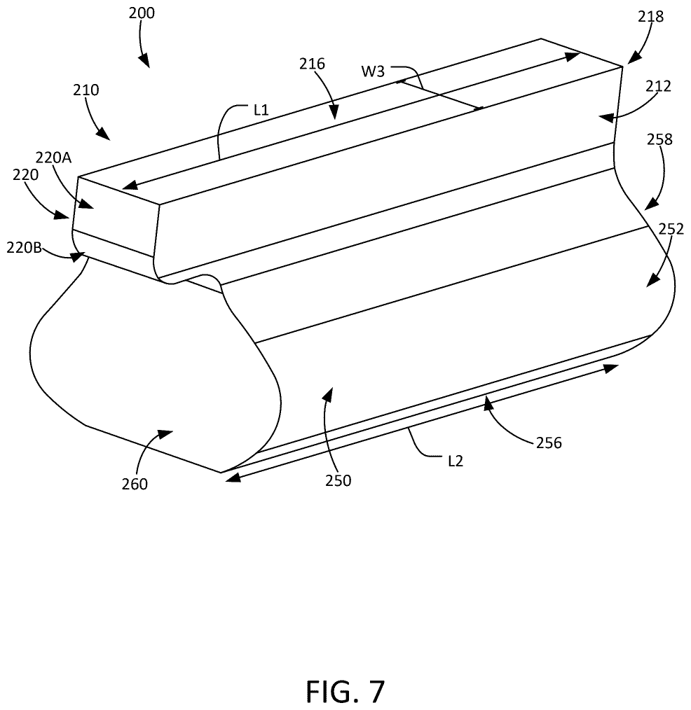

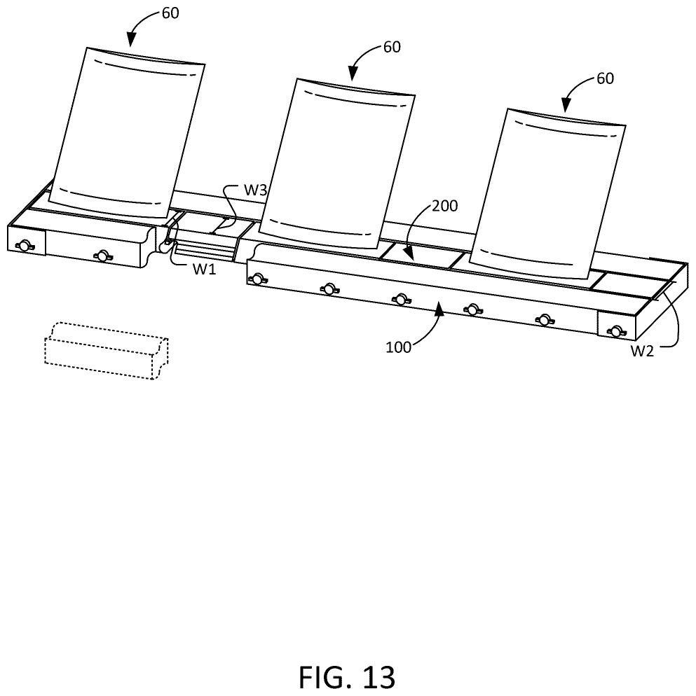

FIG. 7 shows an interspacer 200, according to an aspect of the disclosure. The term “interspacer,” as used herein, refers to a device that fills in a space between two objects. As discussed herein, each interspacer 200, once inserted into the insertion area 108 of the masking system 100 between two adjacent compressor blades 60, may serve to close gap 110 that would have otherwise existed between these compressor blades 60 (see FIG. 13). The interspacer 200 may further ensure that each compressor blade 60 within insertion area 108 of masking system 100 is spaced apart from an adjacent compressor blade 60 by the same distance, which may enhance consistency of coating.

Interspacer 200 may have an upper portion 210 and a lower portion 250. Upper portion 210 may be disposed above lower portion 250. In some examples, interspacer 200 may have a unitary or one-piece construction.

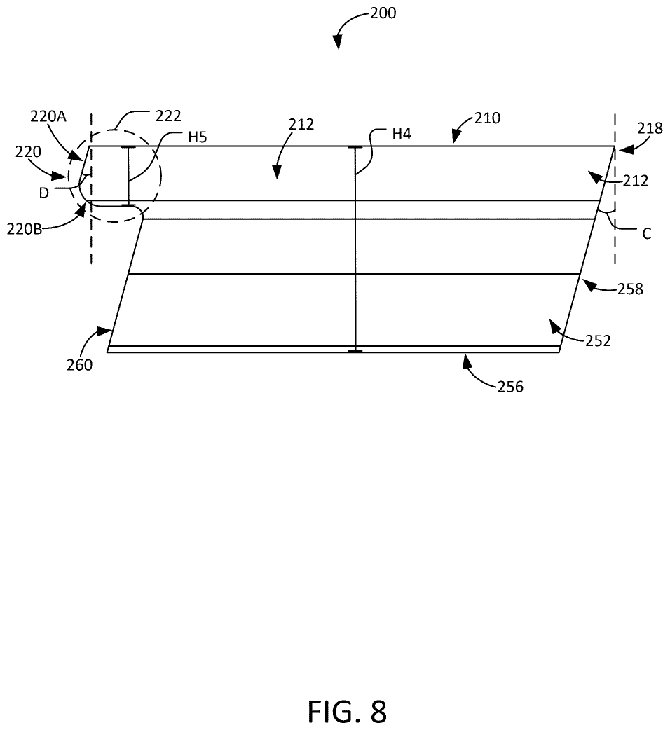

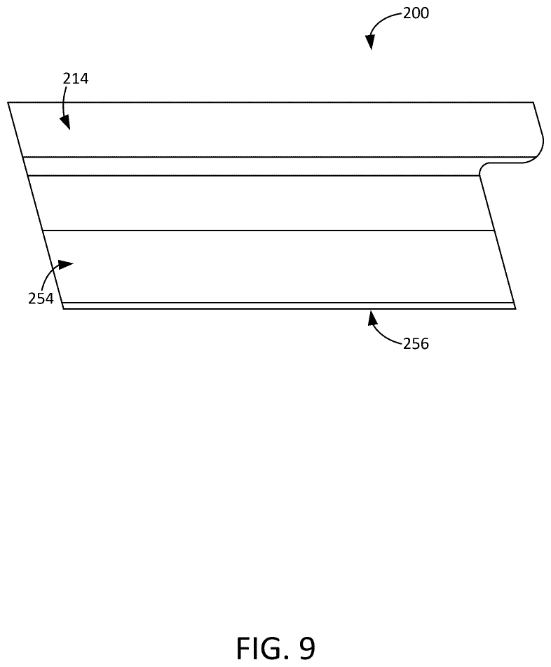

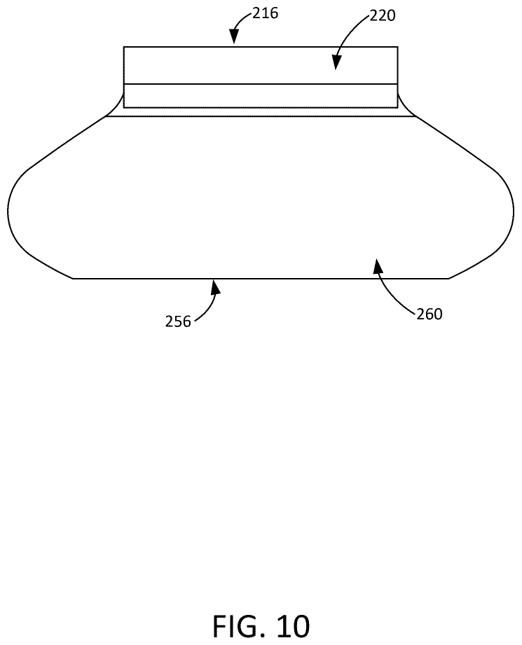

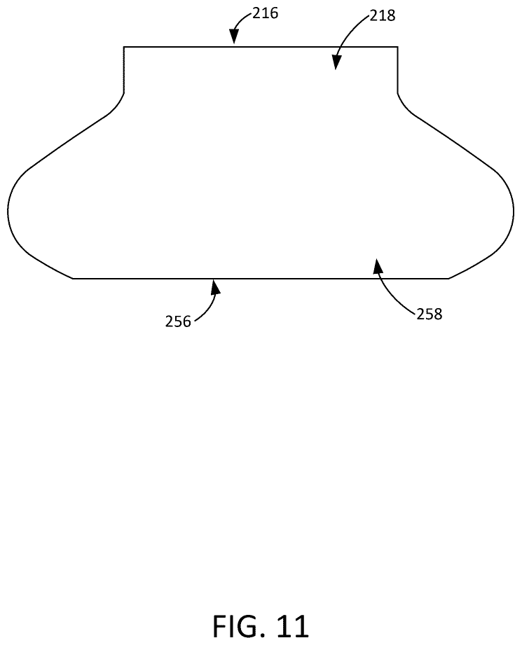

Upper portion 210 may include a first side 212 (see FIGS. 7-8), a second side 214 (see FIG. 9), a top side 216 (see FIG. 7), a first end 218 (see FIGS. 7-8 and 11), and a second end 220 (see FIGS. 7-8 and 10). First side 212 may oppose second side 214, and first end 218 may oppose second end 220. Each of first side 212 and second side 214 may extend laterally from first end 218 to second end 220. Top side 216 may extend above each of first side 212, second side 214, first end 218, and second end 220. In some examples of the embodiments, each of first side 212, second side 214, top side 216, and first end 218 may be planar or generally planar, whereas the second end 220 may have a first section 220A that is generally planar and a second section 220B that is curved (see FIG. 8). The second section 220B of second end 220 may, in some examples, be below the first section 220A. In some examples, upper portion 210 may generally resemble a rectangular prism. In other examples, upper portion 210 may be generally spherical, triangular, cylindrical, or be formed in other symmetrical or asymmetrical shapes.

Lower portion 250 may include a first side 252 (see FIGS. 7-8), a second side 254 (see FIG. 9), a bottom side 256 (see FIG. 7), a first end 258 (see FIGS. 7-8 and 11), and a second end 260 (see FIGS. 7-8 and 10). First side 252 may oppose second side 254, and first end 258 may oppose second end 260. Each of first side 252 and second side 254 may be curved, whereas bottom side 256 may be generally planar. As such, lower portion 250 may have a generally bulbous or double frusto-elliptical shape. In some examples of the embodiments, in shape and size, first end 218 of upper portion 210 of interspacer 200 may generally correspond to first edge 88 (see FIG. 3C) of platform 83 of compressor blade 60, and first end 258 of lower portion 250 of interspacer 200 may generally correspond to first end 78 (see FIG. 3C) of root portion 72 of compressor blade 60.

In some examples, first end 218 of upper portion 210 of interspacer 200 and first end 258 of lower portion 250 may be planar. First end 218 may form an angle C with the vertical (see FIG. 8). In some aspects of the embodiments, angle C may generally correspond to angle A (i.e., angle between first edge 88 of platform 83 of compressor blade 60 and the vertical, see FIG. 3B). That is, when first end 78 of root portion 72 of compressor blade 60 is situated adjacent and in contact with first end 258 of interspacer 200, first end 78 of root portion 72 of compressor blade 60 may extend abuttingly parallel to first end 258 of lower portion 250 of interspacer 200.

First section 220A of second end 220 of upper portion 210 of interspacer 200 may form an angle D with the vertical (see FIG. 8). In some examples, angle D may generally correspond to angle B (i.e., the angle between second edge 90 of platform 83 of compressor blade 60 and the vertical, see FIG. 3B). That is, when first section 220A of second end 220 of upper portion 210 of interspacer 200 is situated adjacent and in contact with second edge 90 of platform 83 of compressor blade 60, the first section 220A of second end 220 of upper portion 210 of interspacer 200 may extend abuttingly parallel to second edge 90 of platform 83 of compressor blade 60.

As noted, top surface 94T (see FIG. 3A) of projection 92 may be curved, and second section 220B of upper portion 210 of interspacer 200 may likewise be curved. In some examples, the curve of top surface 94T of projection 92 may generally correspond to the curve of second section 220B of upper portion 210 of interspacer 200 such that second section 220B of upper portion 210 of interspacer 200 may mate with top surface 94T of projection 92 of compressor blade 60.

Upper portion 210, e.g., top side 216 thereof, may have a length L1 and a width W3 (see FIG. 7). In some examples of the embodiments, length of upper portion 210 of interspacer 200 may be greater than length of lower portion 250 thereof. For example, as can be seen in FIG. 7, length L1 of top side 216 of upper portion 210 of interspacer 200 may be greater than a length L2 of bottom side 256 of lower portion 250 thereof. This difference in the length of the upper portion 210 and lower portion 250 of interspacer 200 may cause a portion (hereinafter “projecting member 222”, see FIG. 8) of upper portion 210 of interspacer 200 to project or extend beyond lower portion 250.

Interspacer 200 may have a height H4 (see FIG. 8), and upper portion 210 thereof may have a height H5. In some examples, a height of lower portion 250 may be greater than height H5 of upper portion 210.

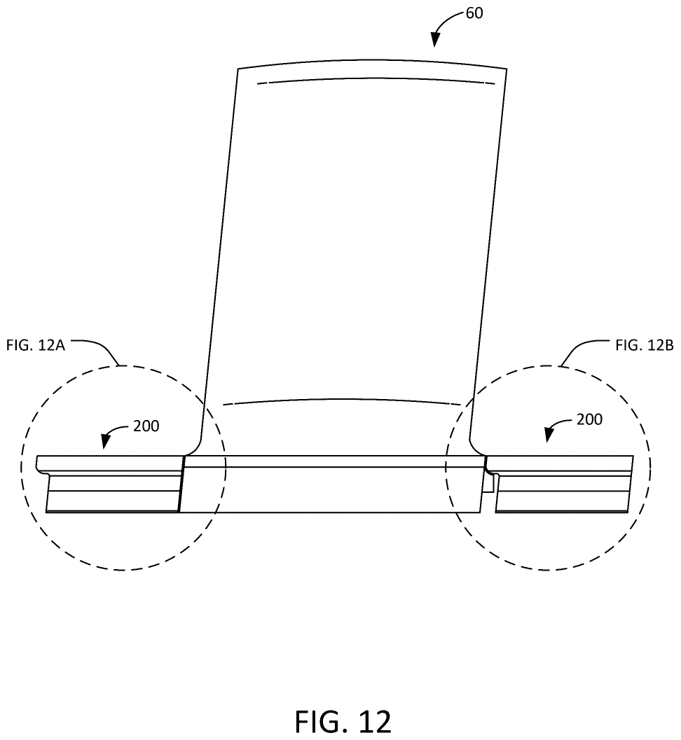

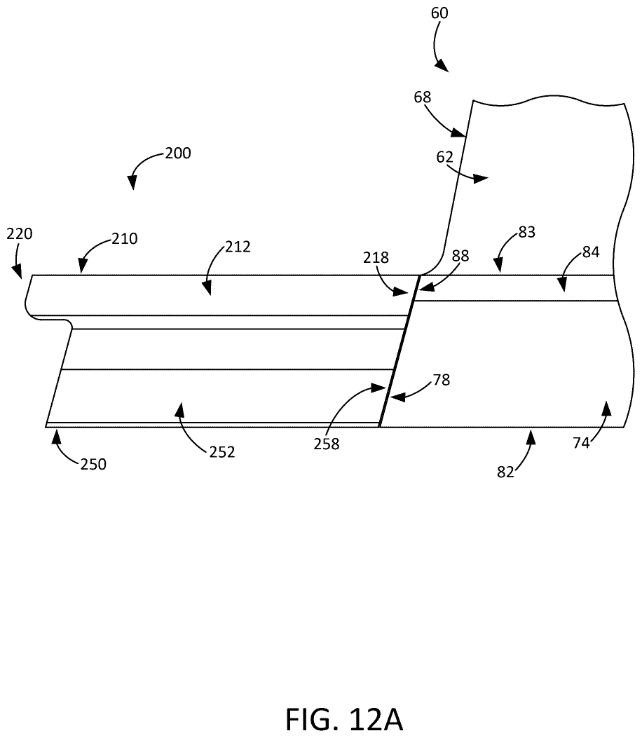

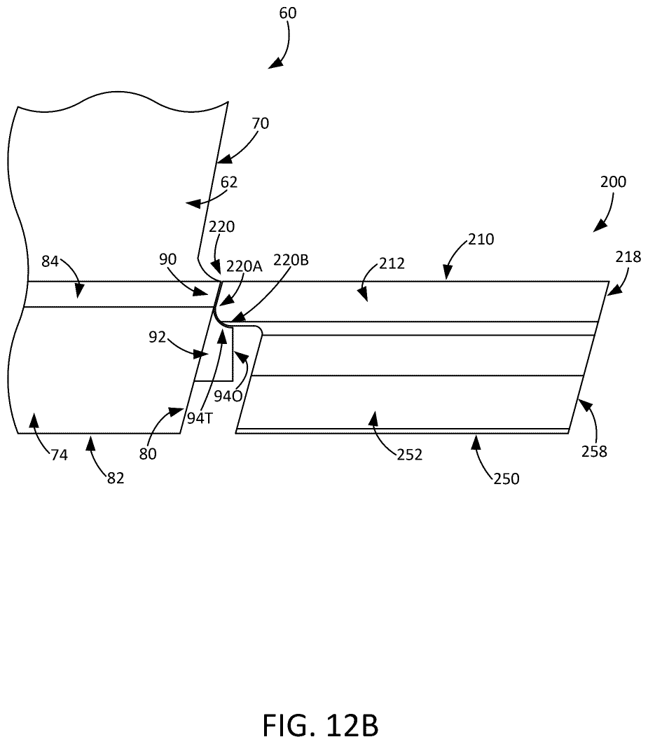

Focus is directed now to FIGS. 12, 12A, and 12B, to illustrate the relationship between different portions of compressor blade 60 and interspacer 200 when compressor blade 60 and interspacer 200 are disposed adjacent and in contact with each other. In particular, FIG. 12 illustrates the relationship between: (a) compressor blade 60—specifically first end 78 of root portion 72 and first edge 88 of platform 83 thereof, and interspacer 200—specifically first end 218 of upper portion 210 and first end 258 of lower portion 250 thereof (see FIG. 12A); and (b) compressor blade 60—specifically second edge 90 of platform 83 and projection 92 at second end 80 of root portion 72, and interspacer 200—specifically second end 220 of upper portion 210 thereof (see FIG. 12B).

In more detail, FIG. 12A shows an interspacer 200 disposed adjacent compressor blade 60 below leading edge 68 of airfoil 62 thereof such that: (i) first end 78 of root portion 72 of compressor blade 60 abuts first end 258 of lower portion 250 of interspacer 200; and (ii) first edge 88 of platform 83 of compressor blade 60 abuts first end 218 of upper portion 210 of interspacer 200. As noted above, first end 78 of root portion 72 of compressor blade 60 and first edge 88 of platform 83 thereof may be planar and may form an angle A (FIG. 3B) with the vertical; and first end 218 of upper portion 210 of interspacer 200 and first end 258 of lower portion 250 thereof may be planar and may form an angle C (FIG. 8) with the vertical. In some examples, angle A and angle C may be equal or generally equal. Thus, when first end 78 of root portion 72 of compressor blade 60 is situated adjacent and in contact with first end 258 of lower portion 250 of interspacer 200, first end 78 of root portion 72 of compressor blade 60 may extend abuttingly parallel to first end 258 of lower portion 250 of interspacer 200; and similarly, first edge 88 of platform 83 of compressor blade 60 may extend abuttingly parallel to first end 218 of upper portion 210 of interspacer 200.

In some examples of the embodiments, height H3 (see FIG. 3B), i.e., the combined height of the root portion 72 and platform 83 of compressor blade 60, may be equal to height H4 (see FIG. 8) of interspacer 200. Therefore, once first end 258 of lower portion 250 of interspacer 200 is placed in contact with first end 78 of root portion 72 of compressor blade 60 as shown in FIG. 12, top edge 91 (see FIG. 5) of platform 83 of compressor blade 60 and top side 216 (see FIG. 7) of upper portion 210 of interspacer 200 may extend in the same or generally the same horizontal plane (see also FIG. 13). Further, width W1 (see FIG. 5) of top edge 91 of platform 83 of compressor blade 60 and width W3 (see FIG. 7) of top side 216 of upper portion 210 of interspacer 200 may be generally equal, and as such, upper portion 210 of interspacer 200 may extend longitudinally along the entire width W1 of top edge 91 of platform 83 of compressor blade 60 (see also FIG. 13).

FIG. 12 also shows another interspacer 200 disposed adjacent compressor blade 60 below trailing edge 70 of airfoil 62 such that second end 220 of upper portion 210 of interspacer 200 is adjacent and in contact with second edge 90 of platform 83 (see FIG. 12B). More specifically, when interspacer 200 is so disposed adjacent compressor blade 60: (a) first section 220A (see also FIG. 8) of second end 220 of upper portion 210 of interspacer 200 abuts second edge 90 of platform 83 of compressor blade 60; and (b) second section 220B of second end 220 of upper portion 210 of interspacer 200 contacts and rests atop top surface 94T of projection 92 of compressor blade 60. As noted above, second section 220B of second end 220 of upper portion 210 of interspacer 200 may be curved, and top surface 94T of projection 92 extending from second end 80 of root portion 72 of compressor blade 60 may also be curved. These curves may correspond or generally correspond to each other, and top side 216 (see FIG. 7) of upper portion 210 of interspacer 200 may consequently extend in the same horizontal plane as the top edge 91 (see FIG. 5) of platform 83 of compressor blade 60 along the entire width W1 of top edge 91 of platform 83.

FIG. 13 shows root portions 72 (see FIG. 3A) of three compressor blades 60 disposed within the insertion area 108 (see FIG. 4) of the masking system 100. In the illustrated example, three interspacers 200 are also disposed within the insertion area 108 such that root portion 72 (see FIG. 3A) of each compressor blade 60 has at least one interspacer 200 adjacent thereto and in contact therewith.

As noted above, width W1 (see FIG. 5) of top edge 91 of platform 83 of compressor blade 60 and width W3 (see FIG. 7) of top side 216 of upper portion 210 of interspacer 200 may be generally equal, and as such, when first end 258 of lower portion 250 of interspacer 200 is disposed adjacent and in contact with first end 78 of root portion 72 of compressor blade 60, upper portion 210 of interspacer 200 may extend longitudinally along the entire width W1 of top edge 91 of platform 83 (see FIG. 13). In some examples, width W1 and width W3 may each be equal or generally equal to width W2 (see FIG. 4) of insertion area 108. As such, each of top edge 91 of platform 83 and top side 216 of upper portion 210 of interspacer 200 may generally extend along the entire width W2 of the insertion area.

As also noted above, height H3 (see FIG. 3B), i.e., the combined height of the root portion 72 and platform 83 of compressor blade 60, and height H4 (see FIG. 8) of interspacer 200, may be equal or generally equal. In some examples, these heights H3 and H4 may be equal to height H6 of the insertion area 108 of the masking system 100 (see FIG. 4). As such, once root portions 72 of compressor blades 60 and interspacers 200 are disposed within the insertion area 108, top edge 91 of platform 83 of each compressor blade 60, top side 216 of upper portion 210 of each interspacer 200, and each of top side 104T of first member 104 and top side 106T of second member 106 of masking system 100, may extend in the same or generally the same horizontal plane.

Furthermore, the configuration of the interspacer 200, e.g., of the projecting member 222 (see FIG. 8) thereof, may ensure that there is no gap between the second edge 90 of platform 83 of compressor blade 60 and second end 220 of interspacer 200 disposed adjacent and in contact with that compressor blade 60, notwithstanding the projection 92 that extends from second end 80 of root portion 72 of that compressor blade 60. The interspacer 200 may therefore effectively close the gap 110 (see FIG. 5) that would have otherwise existed between two adjacent compressor blades 60 disposed within the insertion area 108.

Compressor blades 60, i.e., their root portions 72, and interspacers 200, may be arranged within the insertion area 108 such that there is at least one interspacer 200 adjacent and in contact with each root portion 72. Compressor blades 60 may then be selectively coated while their root portions 72, together with interspacers 200, are retained within the insertion area 108. The interspacers 200 may ensure that no other surface of the compressor blades 60 is coated, or at least that inadvertent application of coating of the other surfaces of the compressor blades 60 is minimized.

Interspacer 200 may be fabricated through a variety of processes and from a variety of materials (e.g., metals, polymers, et cetera). In some examples of the embodiments, one or more of upper portion 210 and lower portion 250 of interspacer 200 may be manufactured and assembled using conventional machining and assembly techniques. In other examples of the embodiments, one or more of upper portion 210 and lower portion 250 of interspacer 200 may be additively manufactured. There are several known additive printing methods such as a material extrusion method, a material jetting method, a binder jetting method, a sheet lamination method, a vat photo-polymerization method, a powder bed fusion method, a directed energy deposition (DED) method, et cetera. Any one or more of these methods, or any other additive manufacturing method, now known or hereinafter developed, may be employed to manufacture one or more of upper portion 210, lower portion 250, or any other part of interspacer 200. In some examples, the entire interspacer 200 may be manufactured via an additive manufacturing method as a unitary device.

In some examples, interspacer 200 may be manufactured using the same material or materials of which compressor blade 60 is made. For example, where compressor blade 60 primarily includes stainless steel (e.g., grade 316 or another grade), the interspacers 200 may also be manufactured (such as additively manufactured) using stainless steel. One benefit of such construction is that the diffusion aluminide coating may interact with the compressor blade 60 and the interspacers 200 in the same way. For example, if there is any gap inadvertently left between the interspacer 200, the compressor blade 60, and/or the insertion area 108 such that diffusion aluminide coating passes through that gap, at least a portion of this coating may interact with the interspacer 200 instead of the compressor blade 60 (e.g., root portion 72 thereof) because the interspacer 200 and compressor blade 60, because of their similar constitution, may attract this coating in generally the same way. Thus, manufacturing the interspacer 200 with the same material(s) as the compressor blade 60 may minimize potentially adverse effects of coating that passes through gaps between one or more of the interspacer 200, the compressor blade 60, and/or the insertion area 108.

In other examples, interspacer 200 may be made using another suitable material or materials, such as metals, metal alloys, plastics, thermoplastics, composite materials, or any other suitable material (e.g., any suitable additively-printable material). In high-temperature coating applications, interspacer 200 may be made using material that can withstand the temperatures encountered during the coating process.

An interspacer 200, once disposed within insertion area 108 in contact with compressor blade 60 as discussed above, may also advantageously ensure equal spacing between one compressor blade 60 and the compressor blade 60 on either side thereof. That is, first end 78 of root portion 72 of each compressor blade 60 may be spaced apart from the second end 80 of the compressor blade 60 nearest thereto by the same distance. Such uniformity may improve coating consistency and process stability.

While the disclosure above generally discusses the use of interspacer 200 with masking system 100 to selectively coat compressor blade 60, the interspacer 200 may likewise be used to facilitate selective coating of other components of gas turbine engine 1 (such as fan blade 40, a turbine blade, et cetera). Further, interspacer 200 may likewise be used to facilitate selective coating of other components, such as components for use in the automotive industry, the shipping industry, or another industry.

Moreover, while interspacer 200 has been discussed above in connection with a coating process, the interspacer 200 may likewise be used to selectively shield one or more portions of the compressor blade 60 or another component for a different process. For example, the interspacer 200 may be used when peening, selectively grit blasting, or sanding an airfoil 62 of the compressor blade 60, to ensure that the media does not impact the root portion 72 thereof.

The use of interspacer 200 to selectively applying diffusion aluminide coating to compressor blade 60 is merely exemplary, and interspacer 200 may likewise be used when selectively applying one or more other coatings (e.g., thermal barrier coatings) to a component. The size of each of the masking system 100 and the interspacer 200 may be reconfigured as desired depending on the application. For example, the length of masking system 100 may be extended to allow for selective coating of five, ten, or more compressor blades 60 or other components at the same time.

As used herein, the terms “first,” “second,” “third”, and “fourth” may be used interchangeably to distinguish one component from another and are not intended to signify location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The singular forms “a,” “an,” and “the” include plural references unless the context clearly dictates otherwise.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

1. An interspacer configured to be disposed in an area of a device, the area having a height, the interspacer comprising:
a lower portion having a first end and a second end; and
an upper portion extending above the lower portion and having a projecting member, the projecting member extending beyond the second end away from the first end;
wherein, a height of the interspacer is equal to the height of the area.

2. The interspacer of claim 1, wherein the projecting member includes a projecting member end, the projecting member end including a curved portion and an angled portion.

3. The interspacer of claim 2, wherein the angled portion is above the curved portion.

4. The interspacer of claim 1, wherein at least one of the first end and the second end extends non-perpendicularly from a bottom side of the lower portion.

5. The interspacer of claim 1, wherein the lower portion further includes a first side and a second side, at least one of the first side and the second side being curved.

6. The interspacer of claim 1, wherein the lower portion has a bulbous shape.

7. The interspacer of claim 1, wherein the upper portion has a top side and the lower portion has a bottom side, the top side and bottom side extending parallel to each other.

8. The interspacer of claim 1, wherein a width of the interspacer is equal to a width of the area.

9. The interspacer of claim 8, wherein the interspacer is additively manufactured.

10. A method of selectively coating a component using an interspacer and a masking device, the component having a projection, the interspacer having a lower portion and an upper portion, the upper portion having a projecting member, the method comprising:
situating the component in an insertion area of the masking device; and
disposing an interspacer in the insertion area such that the projecting member contacts the component above the projection.

11. The method of claim 10, wherein the component is a gas turbine component.

12. The method of claim 11, wherein the gas turbine component is a blade.

13. The method of claim 12, wherein the blade is a compressor blade.

14. The method of claim 10, further including selectively applying a coating to the component while the projecting member is in contact with the component.

15. The method of claim 14, wherein the coating is diffusion aluminide coating.

16. The method of claim 10, wherein the lower portion has an end that extends non-perpendicularly from a bottom side of the lower portion in correspondence with the component.

17. A method of selectively shielding a component undergoing a process using an interspacer, the component having a projection, the interspacer including a lower portion and an upper portion that extends above the lower portion, the upper portion having a projecting member, the method comprising:
disposing the interspacer and at least a portion of the component within an insertion area of a masking device such that the projecting member contacts the component above the projection.

18. The method of claim 17, wherein the projecting member has a curved area, a curve of the curved area corresponding to an upper surface of the projection.

19. The method of claim 17, wherein the component is a gas turbine component.

20. The method of claim 19, wherein the process is a coating process of the gas turbine component.
